(19) United States
(12) Patent Application Publication
(10) Pub. No.: US 2008/0218165 A1
(43) Pub. Date: Sep. 11, 2008

(54) Microsensor Device

(75) Inventors: Josephus Arnoldus Henricus Maria Kahlman, Tilburg (NL); Bart Michiel De Boer, Den Bosch (NL); Albert Hendrik Jan Immink, Eindhoven (NL); Jeroen Hans Nieuwenhuis, Waalre (NL)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 12/065,612

(22) PCT Filed: Sep. 7, 2006
(86) PCT No.: PCT/IB2006/053146

§ 371 Date: Mar. 4, 2008

(30) Foreign Application Priority Data
Sep. 8, 2005 (EP) 05108225.3

(51) Int. Cl. G01N 27/72

(52) U.S. Cl. 324/260

(57) ABSTRACT

The invention relates to a microsensor device like a magnetic biosensor (100). The microsensor device comprises an array of probe-sensors (10.1, 10.2, 10.3) for the measurement of a physical quantity, for example the concentration of molecules labeled with magnetic beads in a sample chamber. The array further comprises a reference-sensor (10.4) that is disposed close to the probe-sensors (10.1, 10.2, 10.3) but shielded from the physical quantity to be measured. The measuring signal of the reference-sensor (10.4) reflects the influence of environmental conditions like temperature and can therefore be used to correct the measuring signals of the probe-sensors (10.1, 10.2, 10.3). The sensors (10.1, 10.2, 10.3, 10.4) are connected via a multiplexer to the same detector unit for further processing in order to minimize variations and to reduce hardware complexity.

The invention relates to a microsensor device for the determination of a physical quantity, particularly to a magnetic biosensor with an array of sensors. Moreover, the invention relates to a method for the determination of a physical quantity that may be executed with said microsensor device. Further, the invention relates to a use of a reference sensor in a microsensor device.

From the WO 2005/010543 A1 and WO 2005/010542 A2 a microsensor device is known which may for example be used in a microfluidic biosensor for the detection of biological molecules labeled with magnetic beads. The microsensor device is provided with an array of the sensors comprising wires for the generation of a magnetic field and Giant Magneto Resistances (GMR) for the detection of stray fields generated by magnetized beads. A problem of such microsensor devices is that the effective gain of the measurement is sensitive to temperature and drift effects in the sensor chip (GMR, field generating wires) and the detection electronics (stability of current sources, filter components etc.). Said effects largely decrease the sensor accuracy. Furthermore, because of the complexity of the detection electronics, reading a multi-sensor biosensor chip requires a lot of hardware.

Based on this situation it was an object of the present invention to provide cost-effective means that allow a more robust and accurate measurement of physical quantities, particularly in biosensor applications.

This object is achieved by a microsensor device according to claim 1, a method according to claim 11, and a use of a reference sensor in a microsensor device according to claim 14. Preferred embodiments are disclosed in the dependent claims.

According to its first aspect, the invention relates to a microsensor device for the determination of a physical quantity like a field strength (e.g. of a magnetic, electrical, or gravitational field), a positional parameter (e.g. spatial position, orientation, velocity, or acceleration), a temperature of the like. The microsensor device may particularly be a biosensor device for measuring a biologically or biochemically relevant quantity like the concentration of a substance in a fluid. The microsensor device comprises the following components:

a) At least one probe-sensor for measuring said physical quantity.
b) At least one reference-sensor for measuring a reference value of the physical quantity. In contrast to the values of the physical quantity measured by the probe-sensor, the reference value of the physical quantity is by definition known in advance, e.g. not affected by the biochemical binding process.
c) A detector unit for processing the signals of said sensors (i.e. of the probe-sensor and of the reference-sensor). The detector unit may particularly amplify, filter and/or convert said signals.
d) A multiplexer for selectively coupling the detector unit to the sensors (i.e. to the probe-sensor and to the reference-sensor).

It should be noted that above and in the following a reference to “the probe-sensor” is intended to comprise all probe-sensors related to the same reference-sensor if more than one such probe-sensor is present. The same applies mutatis mutandis to the expression “the reference-sensor”. Moreover, the microsensor device may have several sets that each comprise probe-sensors, reference-sensors, a detector unit and a multiplexer, wherein the sets work independently of each other.

Typically the microsensor device comprises an array of (up to several thousand) probe-sensors with a smaller number of reference-sensors being integrated into said array. The probe-sensor and the reference-sensor are preferably copies of each other, i.e. identical in layout and design. They may even be identical as such; in this case it must however be guaranteed that they measure the unknown physical quantity when functioning as probe-sensor and that they measure the reference value of said physical quantity when functioning as a reference-sensor.

An advantage of the described microsensor device is that it provides both direct measurements of the unknown value of a physical quantity and measurements of a known reference value, wherein the reference measurements allow conclusions on possible disturbances of the measurements. Taking the reference measurements into account during an evaluation of the measuring signals provided by the probe-sensors can therefore significantly improve the accuracy of the results and make them robust against variations of environmental conditions.

Preferably the probe-sensor and the reference-sensor are designed such that in practice both sensors experience substantially the same environmental conditions (e.g. temperature, electrical or magnetic fields). The measuring values provided by the probe-sensor and the reference-sensor will therefore be influenced by the environmental conditions exactly in the same way, thus allowing to compensate said influences on the probe-sensor by taking the measurements of the reference-sensor into account.

According to a preferred embodiment of the invention, the spatial distance between the probe-sensor and the reference-sensor is less than ten times, preferably less than two times the maximal diameter of these sensors (i.e. the maximal possible distance between two points on the boundary of the probe-sensor or the reference-sensor). This demanded proximity of the probe-sensor and the reference-sensor guarantees that they experience essentially the same environmental conditions (as the latter typically vary on a scale larger than said maximal diameter of the sensors).

In another embodiment of the microsensor device, the probe-sensor and the reference-sensor are thermally coupled. Such a thermal coupling may for example be achieved by an attachment of both sensors to the same carrier and/or by linking them with a material of high thermal conductivity (e.g. a metal). A tight thermal coupling of the sensors guarantees that they will always be at substantially the same temperature which is one of the most important environmental conditions that influences and disturbs (electrical) measurements.

The multiplexer of the microsensor device is preferably designed in such a way that environmental conditions are substantially spatially uniform within it. Such a homogeneity of environmental conditions guarantees that different hardware components of the multiplexer which are only active in combination with certain sensors will be influenced in the same way by environmental conditions. Thus no discrepancies between the measurements of probe-sensor and reference-sensor can occur due to differences in the readout-path.

There are several different methods to guarantee that the reference-sensor will measure a known reference value of the physical quantity. According to a preferred embodiment, the reference-sensor is shielded from any influences of the physical quantity, i.e. the reference value of this physical quantity is zero. If the physical quantity is for instance generated by a sample in a sample chamber, the reference-sensor may simply be disposed far enough from said chamber or be disposed behind impermeable materials to be out of the reach of the physical quantity.

As was already mentioned, the microsensor device may in principle be designed to determine any physical quantity of interest. In a preferred embodiment, the probe-sensor and/or the reference-sensor comprise circuits for the generation of an electromagnetic field (wherein this term shall also comprise pure magnetic fields and pure electric fields). Additionally or alternatively, said sensors may also comprise circuits for the detection of an electromagnetic field, particularly a GMR or TMR (Tunnel Magneto Resistance) or AMR (Anisotropic Magneto Resistance). If both circuits for the generation and the detection of electromagnetic fields are provided, the microsensor device is especially apt for biosensor applications of the kind referred to above.

In another example of the invention the reference sensor is covered by a layer. Thereby, the reference sensor can be in close proximity to the probe sensor without the reference sensor being exposed to the physical quantity. As the physical quantity does not reach the surface of the reference sensor the reference sensor is not exposed to influences by the physical quantity. By this the reference sensor achieves a high reliability and good properties.

The invention further relates to a method for the determination of a physical quantity comprising the following steps:

a) Measuring the physical quantity with at least one probe-sensor.
b) Measuring a reference value of the physical quantity with a reference-sensor that is substantially subject to the same environmental conditions as the probe-sensor.
c) Processing the signals of the probe-sensor and the reference-sensor sequentially by the same detector unit.
d) Evaluating the measurement of the probe-sensor with respect to the measurement of the reference-sensor.

The evaluation in step d) may for example comprise normalizing the measurement of the probe-sensor by the values of the reference-sensor. This is done preferably by complex signals. As both probe-sensor and reference-sensor are subjected to the same environmental conditions, their measurements are disturbed in the same way, and the influence of the environmental conditions will therefore substantially cancel during the normalization.

According to a preferred embodiment of the method, the probe-sensor and the reference-sensor are operated with similar parameters during measurements. Said parameters may for example comprise the time required for a measurement, the energy dissipated during a measurement, the applied currents and/or voltages, the temperature prevailing at the sensors and the like. An operation with the same parameters additionally assures that measurement conditions are the same for both kinds of sensors and thus cannot have different influences on the measured values.

Preferably the signals of the probe-sensor and the reference-sensor are processed immediately one after the other, i.e. as fast as allowed by the applied hardware. The quick succession of the measurements prevents that environmental conditions can substantially change in the meantime.

Further, the invention relates to the use of a reference sensor covered by a layer in a microsensor device.

In one example the reference sensor is fed with complex signals, i.e. the signal processing is done with complex data. By this the robustness of the processing is improved. The compensated signal accomplished by the reference sensor is given by the formula

$$\vert {A}_{0} {e}^{jϕ} - {A}_{t} {e}^{jθ} \cdot \frac{{A}_{r , 0} {e}^{{jσ}_{0}}}{{A}_{r , t} {e}^{{jσ}_{t}}} \vert ,$$

whereby A₀e^{jφ}−Aₜe^{jθ} denotes the bead vector, i.e. the vector of the magnetic particles in the fluid to be detected by the microsensor device.

These and other aspects of the invention will be apparent from and elucidated with reference to the embodiment(s) described hereinafter. These embodiments will be described by way of example with the help of the accompanying drawings in which:

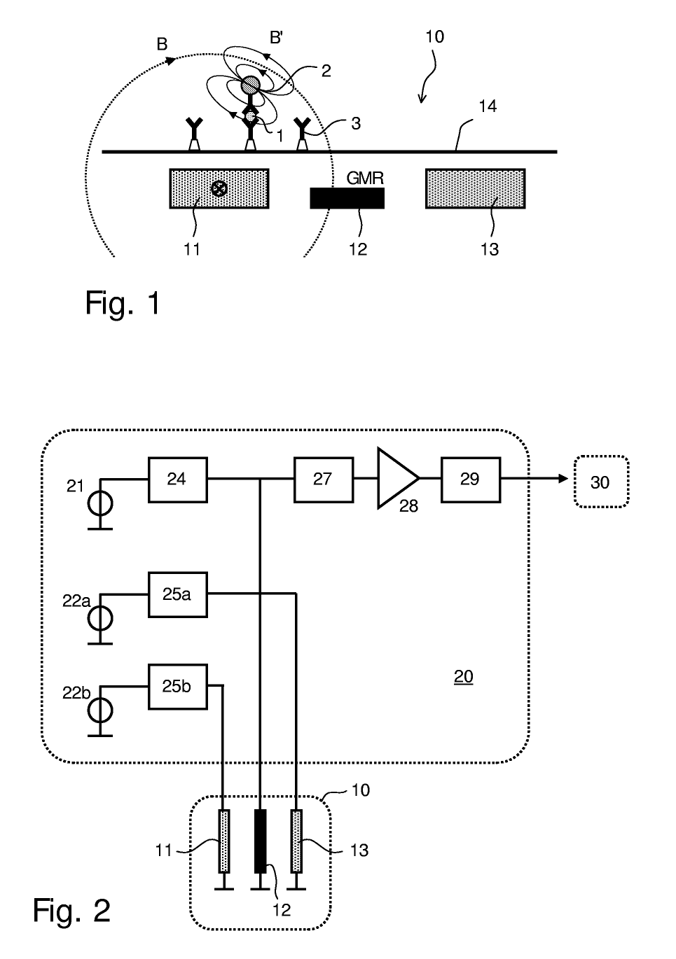

FIG. 1 illustrates the measuring principal of a magnetic biosensor;

FIG. 2 shows the layout of a biosensor device according to the state of the art;

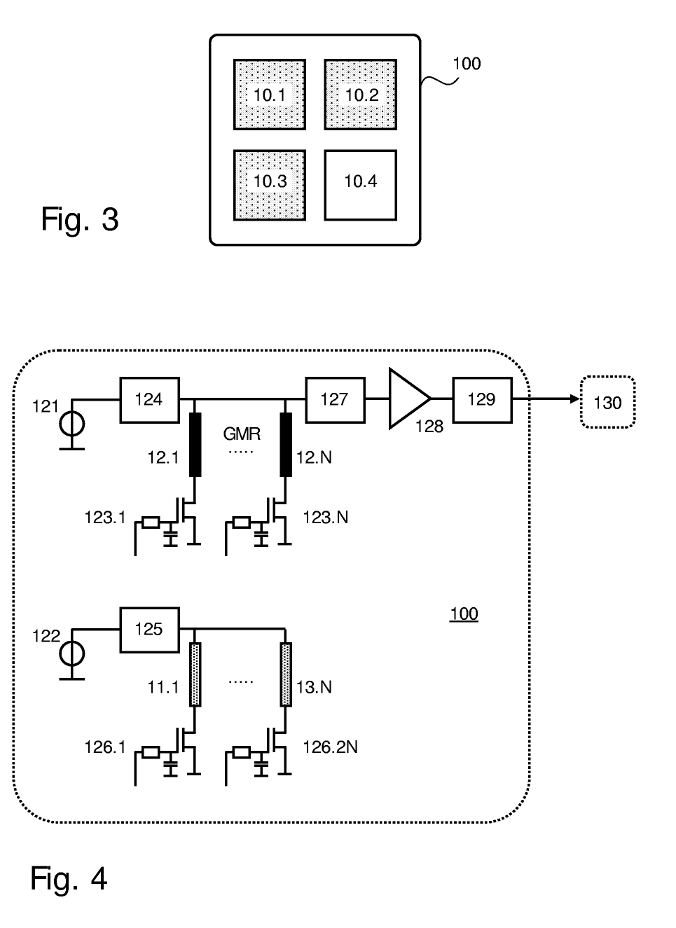

FIG. 3 shows the arrangement of probe-sensors and a reference-sensor in a biosensor device according to the present invention;

FIG. 4 shows the layout of the biosensor device according to the present invention;

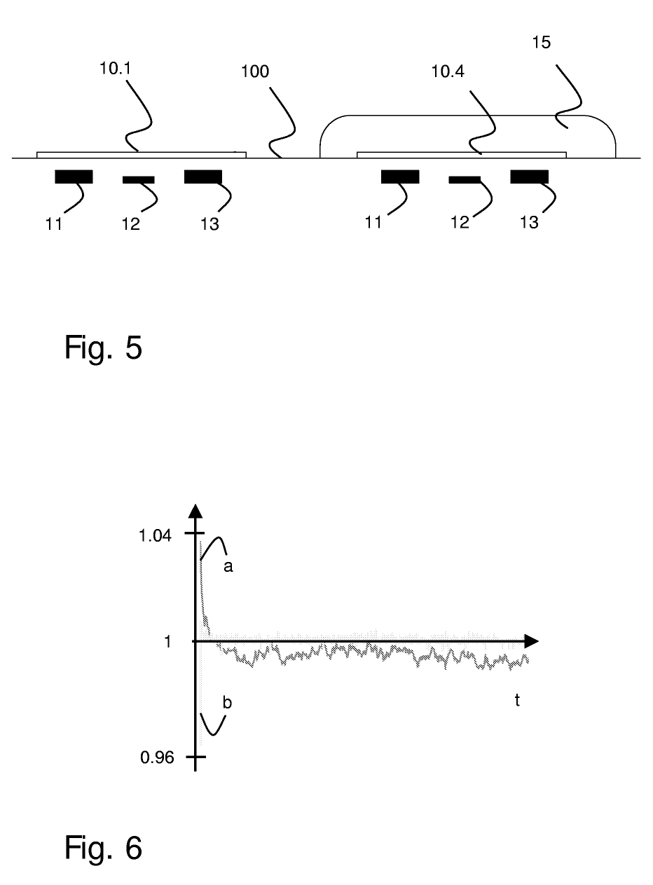

FIG. 5 shows a cross-sectional view of a part of a biosensor with a probe-sensor and a reference sensor;

FIG. 6 shows one curve of a sensor signal without the application of a reference sensor and one curve of a sensor signal with the application of a reference sensor in the microsensor device;

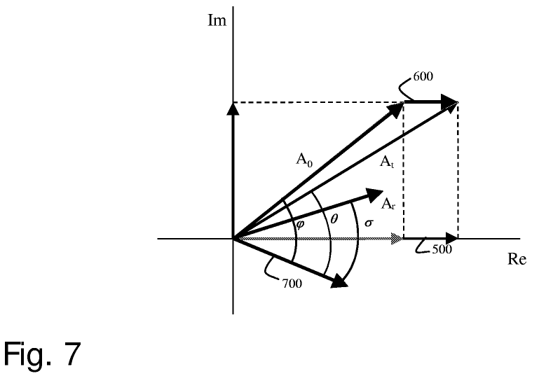

FIG. 7 shows a vector illustration of complex signal processing for enhancing the robustness of the microsensor device.

Like reference numbers in the Figures refer to identical or similar components.

Magneto-resistive biochips have promising properties for bio-molecular diagnostics, in terms of sensitivity, specificity, integration, ease of use, and costs. Examples of such biochips are for example described in WO 2003/054566, WO 2003/054523, WO 2005/010542 A2, WO 2005/010543 A1 or Rife et al. (Sens.Act. A vol. 107, p. 209 (2003)), which are incorporated into the present application by reference.

FIG. 1 illustrates the principle of a single sensor 10 for the detection of superparamagnetic beads 2. A biosensor consisting of an array of (e.g. 100) such sensors 10 may be used to simultaneously measure the concentration of a large number of different biological target molecules 1 (e.g. protein, DNA, amino acids) in a solution (e.g. blood or saliva). In one possible example of a binding scheme, the so-called “sandwich assay”, this is achieved by providing a binding surface 14 with first antibodies 3, to which the target molecules 1 may bind. Superparamagnetic beads 2 carrying second antibodies may then attach to the bound target molecules 1. A current flowing in the wires 11 and 13 of the sensor 10 generates a magnetic field B, which then magnetizes the superparamagnetic beads 2. The stray field B′ from the superparamagnetic beads 2 introduces an in-plane magnetization component in the GMR 12 of the sensor 10, which results in a measurable resistance change.

FIG. 2 shows schematically the layout of the detection electronics 20 that is provided for each sensor 10 of a magnetic biosensor according to the state of the art. Excitation current sources 22a, 22b are connected via filters 25a, 25b to the wires 11, 13 of the sensor 10. Similarly, a sense current source 21 is connected via a filter 24 to the GMR 12 of the sensor 10. A further filter 27, an amplifier 28, and a detection and A/D conversion unit 29 are connected to the GMR 12, too, for the processing and conversion of measuring signals. The processed data are then sent to a back end processor 30 for further processing (e.g. to a personal computer coupled to the electronics 20 via a standard interface like USB). A problem of the shown layout is that several effects change the detection gain of the biosensor system and degrade the accuracy of the measurement:

1. The detection hardware is complex and suffers from gain instability due to temperature effects in components, voltage sources etc.
2. The resistance of the GMR 12 and the field generating wires 11, 13 on the biosensor chip are sensitive to temperature, which will change the currents and thus the overall detection gain, especially at non-ideal current driving. A typical value for the GMR is 0.2%/° C.
3. The GMR sensor sensitivity is temperature dependent (typical value: −0.24%/° C.).
4. The sensitivity of the GMR is affected by external magnetic fields.

The solution proposed here is based on the recognition that said error sources are suppressed when they are made correlated for the biosensor system. It is therefore a first aim to stabilize correlated gain fluctuations in a biosensor chip and the detection hardware. A second aim is to cut down the hardware complexity when measuring multi-sensors on a biosensor chip.

A biosensor that implements the aforementioned concepts comprises at least one reference-sensor and at least one probe-sensor for performing the actual biochemical measurement, wherein said sensors are coupled via multiplexing means to detection means able to detect a signal. By normalizing the detected signal from each probe-sensor by the detected reference-sensor signal, the effective gain of the biosensor system (including the detection hardware) is stabilized. Obviously, measurements are performed fast enough to follow the temperature and drift variations. The normalization is done using complex signals.

FIG. 3 schematically shows the sensitive surface of such a multi-sensor biosensor chip 100 which comprises three common probe-sensors 10.1, 10.2, and 10.3 for the detection of (immobilized) magnetic beads, and one reference-sensor 10.4. The sensors are identical in design and comprise at least one GMR and at least one field-generating wire as shown in FIG. 1. The reference-sensor 10.4 is made insensitive to magnetic beads by mechanical shielding or by simple avoiding antibodies to be present on the surface, so that no beads can immobilize on its surface.

FIG. 4 schematically shows the layout of the biosensor chip 100, wherein the same components as in FIG. 2 have the same reference numbers increased by 100. An excitation current source 122 and a filter 125 can be selectively coupled to any one of the wires 11.1, 13.1, 11.2, 13.2, . . . 11.N, and 13.N (wherein N is the number of sensors associated to the detection unit, i.e. N=4 for FIG. 3). The selection of the wire to be coupled to the source 122 is executed by the analogue switches 126.1, . . . 126.2N (indicated in FIG. 4 by FET switches). Similarly, a sense current source 121 and a filter 124 can be selectively coupled to one of the GMRs 12.1, . . . 12.N with the help of associated analogue switches 123.1, . . . 123.N. The measured signals are sent via one filter 127, one amplifier 128, and one detection and A/D conversion unit 129 to a PC 130.

Via the analogue switches 123.1, . . . 123.N, 126.1, . . . 126.N, the sensors formed by the wires 11.i, 13.i, and GMRs 12.i are actuated and measured successively. Measures are taken for preventing noise injection from said switches into the signal path. In the back-end signal processing the signal uᵢ from each probe-sensor i is normalized by the reference-sensor signal u_{ref}, e.g. according to the formula

$${u}_{i , norm} = \frac{{u}_{ref}}{{u}_{ref , t = 0}} \cdot {u}_{i} .$$

Here u_{ref,t=0} is the reference-sensor signal prior to the actual measurement. Obviously non-immobilized beads may be removed from the surface prior to measuring.

The described approach will correct for (1) correlated gain variations (e.g. temperature effects and external magnetic fields) in the sensor chip and in the detection electronics and (2) limit the electronic complexity when measuring multi-sensors on the chip.

Ideally all sensors are at the same temperature when measured. Therefore they have to be heavily thermally coupled. This is however no serious problem because said sensors are located close to each other on the same biosensor-die and because they are exposed to the same liquid.

In order to achieve an even higher accuracy, each sensor is preferably operated such that the same energy (power) is dissipated, e.g. by using the same measuring time for each sensor. Alternatively each sensor is at a particular temperature, which is constant during each measurement of that particular sensor.

Fluctuations between the multiplexing means must be avoided, too. Here the same measures as for the sensors must be taken, namely an identical design of individual hardware components (especially switches 123.1-123.N, 126.1-126.2N) and maintaining the same temperature during each measurement of a sensor.

FIG. 5 shows a schematic cross-sectional view of a part of a microsensor device 100 or biosensor for magnetic detection as an example. The microsensor device 100 comprises a number of probe-sensors 10.1, 10.2, 10.3 from which one probe-sensor 10.1 is shown in FIG. 5. Near to the probe-sensor 10.1 a reference sensor 10.4 is mounted to the microsensor device 100. According to the description above a current flows through the wires 11 and 13 of the probe-sensor 10.1 as well as through the reference-sensor 10.4 and generates a magnetic field B, which then magnetizes the superparamagnetic beads 2. The stray field B′ of the superparamagnetic beads 2 introduces an in-plane magnetization component in the GMR 12 of the sensor 10.1 and 10.4, which results in a measurable resistance change. The reference sensor 10.4 is covered by a layer 15 which can comprise different materials. In one example the layer 15 consists of the material SU8 which is a commonly used photoresist. For example the layer 15 has a thickness of 30 μm. The application of this layer 15 out of SU8 further has the advantage that the reference sensor 10.4 is, as well as the probe sensors 10.1, located in the fluid chamber, in which the substance to be analyzed is located, where it is exposed to the same fluid flow, and therefore equally exposed to temperature variations. The response of the reference sensor 10.4 to temperature variations, e.g. as a result of injection of the sample fluid, will thus be comparable to that of the probe sensors 10.1. Another advantage is that the probe sensors 10.1 and the reference sensor 10.4 are in close proximity to each other, such that they are exposed to the same external magnetic fields which can lead to disturbances in signals. The height of the SU8 layer 15 covering the reference sensor 10.4 of for instance 30 μm is just enough to prevent beads from reaching the sensitive area of the reference sensor 10.4, as the reference sensor 10.4 is only sensitive to beads up to about 30 μm above the surface of the reference sensor 10.4. Beads further than 30 μm away from the surface of the reference sensor 10.4 do not contribute to the signal of the reference sensor 10.4. As already stated the described probe sensors 10.1 and the reference sensor 10.4 can be realized on a single electronic chip, like a biosensor chip.

FIG. 6 shows one curve of a sensor signal without application of a reference sensor 10.4, denoted with (a), and one curve of a sensor signal with the application of a reference sensor in the microsensor device 100, denoted with (b). Shown at the x-axis is the time and at the y-axis the normalized signal. FIG. 6 clearly shows how the compensation scheme described above reduces the sensitivity of the detection platform of the microsensor device 100 to environmental variations. These curves (a), (b) show the signals of a probe sensor 10.1 in a temperature unstable situation and in the absence of magnetized beads. In this situation the signal generated and shown should not change over time, a constant signal at point 1 at the x-axis is ideal. As can be seen the uncompensated probe sensor signal (a) lying mainly underneath compensated signal (b) varies significantly due to temperature variations, most times far from the ideal curve at point 1 at the x-axis. If the signal of the probe sensor 10.1 is compensated using the signal obtained from the reference sensor 10.4 the variations are greatly reduced, which is shown by signal (b). Compensated signal (b) lying mainly above uncompensated signal (a) has much weaker variations than signal (a) and runs continuously nearer to the ideal signal form along the point 1 of the x-axis than signal (a) over the whole range.

FIG. 7 shows a vector illustration of complex signal processing for enhancing the robustness of the microsensor device 100. At the horizontal axis the real part of the complex signal is plotted, denoted as Re, at the perpendicular axis the imaginary part of the complex signal is plotted, denoted as Im. In FIG. 7 the angle φ is drawn between reference vector 700, the vector of the reference sensor 10.4, and the total measurable signal A₀, the angle θ is drawn between the reference vector 700 and the total measurable signal Aₜ, the angle σ is drawn between the reference vector 700 and magnetic cross talk vector Aᵣ. Capacitive and inductive cross talk inherent to the geometry of the microsensor device 100 give rise to a current through circuits for the detection of an electromagnetic field, e.g. a GMR 12, with a frequency equal to the excitation frequency. Furthermore, the applied sense current gives rise to an internal magnetic field in the GMR 12, the self-biasing, at the sense current frequency. Their product results in a signal at the difference of these frequencies Δf, of which the phase is 90 degrees shifted with respect to the information carrying signal. The amplitude of this signal is u-jωαβsIₑₓIₛ, where α equals the quotient of cross talk current I_{c} to the applied excitation current Iₑₓ, I_{c}/Iₑₓ. Further, in the formula above β is the self biasing factor H/I_{GMR}, i.e. the magnetic field strength in the sensitive layer of the GMR 12 induced by current through the GMR 12, and s denotes the sensitivity of the GMR 12, which equals ΔR/ΔH. In FIG. 7 vector A₀ denotes the total measurable signal at frequency Δf in the absence of magnetic beads 2. Vector Aᵣ denotes the magnetic cross talk vector due to inherent misalignment of current wires and GMR 12 resulting in a response of the GMR 12 to the magnetic field induced by the excitation current through the wires. This is described by the formula u=γsIₑₓIₛ, where γ equals the magnetic field strength in the sensitive layer of the GMR 12 induced by a current through the wires which equals Hₑₓ/Iₑₓ. The total magnetic vector is denoted by reference number 500. This is the magnetic cross talk vector Aᵣ added to the bead vector which is given by the formula u=(γ+εB)sIₑₓIₛ, in which c equals the magnetic field strength in the sensitive layer of the GMR 12 induced by magnetised beads 2 at the surface of the sensor 10 given by H_{b}/(BIₑₓ), and B is the density of the beads 2 at the surface of the sensor 10. There is assumed uniform distribution of beads 2 on the surface. The reference number 600 in FIG. 7 denotes the bead vector which is the information carrying signal which is given by the formula u=εBsIₑₓIₛ. Information carrying signal in this context means the signal which characterizes the amount of beads 2 in the fluid and consequently the amount of target molecules 1 bound to the beads 2.

The signal accomplished by compensation of the signal as described above is given by vector 600 in FIG. 7. This signal can be expressed by the formula

$$\vert {A}_{0} {e}^{jϕ} - {A}_{t} {e}^{jθ} \cdot \frac{{A}_{r , 0} {e}^{{jσ}_{0}}}{{A}_{r , t} {e}^{{jσ}_{t}}} \vert ,$$

whereby A₀e^{jφ}−Aₜe^{jθ} denotes the bead vector, i.e. the vector of the magnetic particles in the fluid, the modulus of which is |A₀e^{jφ}−Aₜe^{jθ}| which equals εBsIₑₓIₛ. The term Aᵣ denotes the magnetic cross talk vector, which is variable in time in the formula given above.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A microsensor device for the determination of a physical quantity, comprising
a) at least one probe-sensor for measuring the physical quantity, said probe-sensor comprising circuits for the generation of an electromagnetic field;
b) at least one reference-sensor for measuring a reference value of the physical quantity, said reference-sensor comprising circuits for the generation of an electromagnetic field;
c) a detector unit for processing the signals of said sensors and for supplying the field-generating circuits with energy;
d) a multiplexer for selectively coupling the detector unit to the individual sensors.
e) an evaluation unit for quantitatively evaluating the measurement of the probe-sensor with respect to the measurement of the reference-sensor.

2. The microsensor device according to claim 1, wherein the probe-sensor and the reference-sensor are designed such that they experience substantially the same environmental conditions.

3. The microsensor device according to claim 1, wherein the spatial distance between the probe-sensor and the reference-sensor is less than ten times the diameter of the sensors.

4. The microsensor device according to claim 1, wherein the probe-sensor and the reference-sensor are thermally coupled.

5. The microsensor device according to claim 1, wherein the multiplexer is designed such that environmental conditions are substantially spatially uniform within it.

6. The microsensor device according to claim 1, wherein the reference-sensor is shielded from influences of the physical quantity.

7. The microsensor device according to claim 1, wherein at least one of the probe-sensor and the reference-sensor comprise circuits for the detection of an electromagnetic field.

8. The microsensor device according to claim 7, wherein said at least one of the probe-sensor and the reference-sensor include an integrated circuit at least one wire for the generation of an electromagnetic field and at least one magneto-resistive element, for the detection of an electromagnetic field.

9. The microsensor device according to claim 1, wherein the reference sensor is covered by a layer.

10. The microsensor device according to claim 1, wherein the measurement of the probe-sensor is normalized by complex data of the reference-sensor.

11. A method for the determination of a physical quantity, comprising:
a) measuring the physical quantity with at least one probe-sensor, said probe-sensor comprising circuits for the generation of an electromagnetic field;
b) measuring a reference value of the physical quantity with a reference-sensor that is subject to substantially the same environmental conditions as the probe-sensor, said reference-sensor comprising circuits for the generation of an electromagnetic field:
c) processing the signals of the probe-sensor and the reference-sensor sequentially by the same detector unit, comprising supplying their field-generating circuits with energy;
d) evaluating the measurement of the probe-sensor quantitatively with respect to the measurement of the reference-sensor.

12. The method according to claim 11, wherein the probe-sensor and the reference-sensor operate under similar parameters during a measurement.

13. The method according to claim 11, wherein the signals of the probe-sensor and the reference-sensor are processed immediately one after the other.

14. (canceled)

15. A microsensor device comprising:
one or more probe sensors for measuring a physical quantity, said one or more probe sensors including one or more electromagnetic field generating circuits;
one or more reference sensors which include one or more electromagnetic field generating circuits;
a detector for sequentially processing signals from the one or more probe sensors and the one or more reference sensors; and
a multiplexer for selectively coupling the one or more probe sensors and one or more reference sensors.

16. The microsensor of claim 15 further comprising an evaluation unit.

17. The microsensor of claim 15 wherein the one or, more reference sensors are isolated from the physical quantity by a layer of material.

18. The microsensor of claim 15 wherein the one or more probe sensors and the one or more reference sensors are exposed to similar environmental conditions during measurement.
